(19) United States
(12) Patent Application Publication
(10) Pub. No.: US 2016/0251954 A1
(43) Pub. Date: Sep. 1, 2016

(54) ESTIMATION AND CALIBRATION OF DOWNHOLE BUCKLING CONDITIONS

(71) Applicant: Halliburton Energy Services, Inc., Houston, TX (US)

(72) Inventor: Robello Samuel, Houston, TX (US)

(21) Appl. No.: 14/412,158

(22) PCT Filed: Sep. 17, 2013
(86) PCT No.: PCT/US2013/060171

§ 371 Date: Dec. 30, 2014

(51) Int. Cl. E21B 44/04; G06F 17/11; E21B 7/04; G05B 17/02; E21B 44/00; E21B 41/00

(52) U.S. Cl. CPC E21B 44/04; E21B 44/00; E21B 41/0092; E21B 7/04; G05B 17/02; G06F 17/11

(57) ABSTRACT

A method for estimating an axial force transfer efficiency of a drillstring in a borehole includes lifting the drillstring so that the drill bit is off the bottom of the borehole, measuring a hook load, slacking off a first reference amount of the hook load, determining a first weight on bit at the bottom of the drillstring and determining the axial force transfer efficiency based, at least in part, on the measured hook load, the first weight on bit, and the first reference amount of hook load.

### BACKGROUND

The present disclosure relates generally to subterranean drilling operations and, more particularly, to the estimation and calibration of the axial force transfer efficiency of a drillstring.

Hydrocarbons, such as oil and gas, are commonly obtained from subterranean formations that may be located onshore or offshore. The development of subterranean operations and the processes involved in removing hydrocarbons from a subterranean formation are complex. Typically, subterranean operations involve a number of different steps such as, for example, drilling a wellbore at a desired well site, treating the wellbore to optimize production of hydrocarbons, and performing the necessary steps to produce and process the hydrocarbons from the subterranean formation.

In certain directional drilling applications where the borehole path is tortuous, the drillstring path may deviate from the borehole curvature. Depending on the amount of deviation and the compression of the drillstring, the drillstring may take on a lateral or sinusoidal buckling mode. This may also be referred to as “snaking” of the drillstring. When the drillstring is in the lateral bucking mode, further compression of the drillstring may cause the drillstring enters a helical buckling mode. The helical bucking mode may also be referred to as “corkscrewing.” Buckling may result in loss of efficiency in the drilling operation and premature failure of one or more drillstring components.

### FIGURES

Some specific exemplary embodiments of the disclosure may be understood by referring, in part, to the following description and the accompanying drawings.

FIG. 1 is a diagram of an example drilling system, according to aspects of the present disclosure.

FIG. 2 is a diagram illustrating an example information handling system, according to aspects of the present disclosure.

FIGS. 3-6 are flow charts of an example processes according to aspects of the present disclosure

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to subterranean drilling operations and, more particularly, to the estimation and calibration of the axial force transfer efficiency of a drillstring.

Illustrative embodiments of the present disclosure are described in detail herein. In the interest of clarity, not all features of an actual implementation may be described in this specification. It will of course be appreciated that in the development of any such actual embodiment, numerous implementation-specific decisions are made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Embodiments may be implemented using a tool that is made suitable for testing, retrieval and sampling along sections of the formation. Embodiments may be implemented with tools that, for example, may be conveyed through a flow passage in tubular string or using a wireline, slickline, coiled tubing, downhole robot or the like.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

The present disclosure relates generally to subterranean drilling operations and, more particularly, to the estimation and calibration of the axial force transfer efficiency of a drillstring.

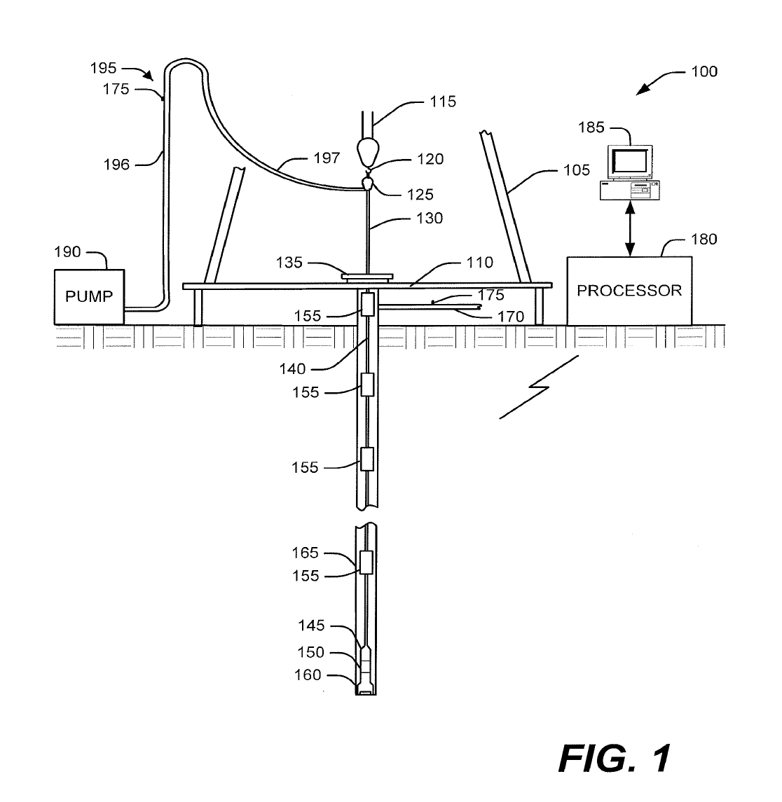

As shown in FIG. 1, oil well drilling equipment 100 (simplified for ease of understanding) may include a derrick 105, derrick floor 110, draw works 115 (schematically represented by the drilling line and the traveling block), hook 120, swivel 125, kelly joint 130, rotary table 135, drillpipe 140, one or more drill collars 145, one or more MWD/LWD tools 150, one or more subs 155, and drill bit 160. Drilling fluid is injected by a mud pump 190 into the swivel 125 by a drilling fluid supply line 195, which may include a standpipe 196 and kelly hose 197. The drilling fluid travels through the kelly joint 130, drillpipe 140, drill collars 145, and subs 155, and exits through jets or nozzles in the drill bit 160. The drilling fluid then flows up the annulus between the drillpipe 140 and the wall of the borehole 165. One or more portions of borehole 165 may comprise open hole and one or more portions of borehole 165 may be cased. The drillpipe 140 may be comprised of multiple drillpipe joints. The drillpipe 140 may be of a single nominal diameter and weight (i.e. pounds per foot) or may comprise intervals of joints of two or more different nominal diameters and weights. For example, an interval of heavy-weight drillpipe joints may be used above an interval of lesser weight drillpipe joints for horizontal drilling or other applications. The drillpipe 140 may optionally include one or more subs 155 distributed among the drillpipe joints. If one or more subs 155 are included, one or more of the subs 155 may include sensing equipment (e.g., sensors), communications equipment, data-processing equipment, or other equipment. The drillpipe joints may be of any suitable dimensions (e.g., 30 foot length). A drilling fluid return line 170 returns drilling fluid from the borehole 165 and circulates it to a drilling fluid pit (not shown) and then the drilling fluid is ultimately recirculated via the mud pump 190 back to the drilling fluid supply line 195. The combination of the drill collar 145, MWD/LWD tools 150, and drill bit 160 is known as a bottomhole assembly (or “BHA”). The combination of the BHA, the drillpipe 140, and any included subs 155, is known as the drillstring. In rotary drilling the rotary table 135 may rotate the drillstring, or alternatively the drillstring may be rotated via a top drive assembly.

A processor 180 may be used to collect and analyze data from one or more sensors and to control the operation of one or more drilling operations. The processor 180 may alternatively be located below the surface, for example, within the drillstring. The processor 180 may operate at a speed that is sufficient to be useful in the drilling process. The processor 180 may include or interface with a terminal 185. The terminal 185 may allow an operator to interact with the processor 180.

In the embodiment shown, the processor 180 may include an information handling system. As used herein, information handling systems may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

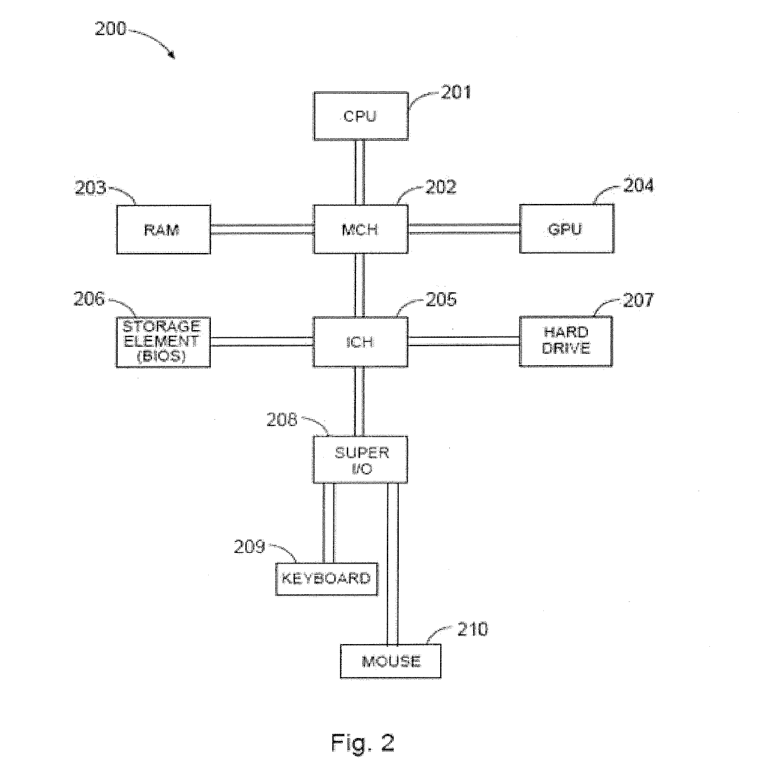

FIG. 2 is a block diagram showing an example information handling system 200, according to aspects of the present disclosure. Information handling system 200 may be used, for example, as part of a control system or unit for a drilling assembly. For example, a drilling operator may interact with the information handling system 200 to alter drilling parameters or to issue control signals to drilling equipment communicably coupled to the information handling system 200. The information handling system 200 may include a processor or CPU 201 that is communicatively coupled to a memory controller hub or north bridge 202. Memory controller hub 202 may include a memory controller for directing information to or from various system memory components within the information handling system, such as RAM 203, storage element 206, and hard drive 207. The memory controller hub 202 may be coupled to RAM 203 and a graphics processing unit 204. Memory controller hub 202 may also be coupled to an I/O controller hub or south bridge 205. I/O hub 205 is coupled to storage elements of the computer system, including a storage element 206, which may comprise a flash ROM that includes a basic input/output system (BIOS) of the computer system. I/O hub 205 is also coupled to the hard drive 207 of the computer system. I/O hub 205 may also be coupled to a Super I/O chip 208, which is itself coupled to several of the I/O ports of the computer system, including keyboard 209 and mouse 210. The information handling system 200 further may be communicably coupled to one or more elements of a drilling assembly though the chip 208.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. It may also include one or more interface units capable of transmitting one or more signals to a controller, actuator, or like device.

For the purposes of this disclosure, computer-readable media may include any instrumentality or aggregation of instrumentalities that may retain data and/or instructions for a period of time in a non-transitory state. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

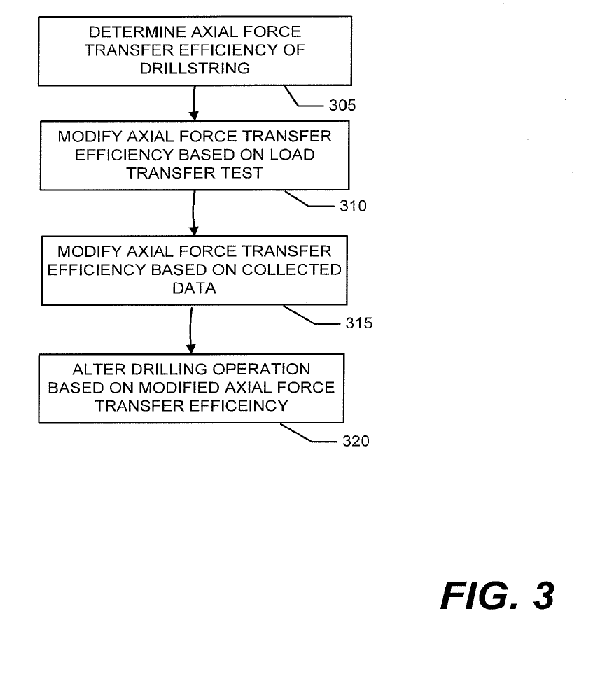

FIG. 3 shows a flow chart of an example process for determining and calibrating the axial force transfer efficiency of a drillstring. In block 305, the process includes determining the axial force transfer efficiency of the drillstring. Example implementations of block 305 are based on wellbore and drillstring models. In block 310, the process includes modifying the axial force transfer efficiency based on a load transfer test. In block 315, the process includes modifying the axial force transfer efficiency based, at least in part, on collected data. In block 320, the process includes altering a drilling operation based on the modified axial force transfer efficiency. Example implementations of block 320 include one or more of altering the rate of penetration of the drill bit 160 in borehole 165, limiting or altering the weight on bit of the drillstring, and limiting or altering the torque on bit of the drillstring. Example embodiments may omit one or more of block 305-315.

Example implementations of determining the axial force transfer efficiency of the drillstring (block 305) include modeling to determine the whether and when the drillstring may experience a lateral buckling mode. One example implementation uses the following equation to determine he force needed to induce onset of sinusoidal buckling.

$${F}_{s} = 2 x \sqrt{\frac{EIW sin θ}{r}} \qquad ( Equation 1 )$$

where I is the moment of inertial for the drillstring component being modeled, E is Young's modulus of elasticity, W is the tubular weight in mud; θ is the wellbore inclination, and r is the radial clearance between wellbore and drillstring component.

Another example implementation uses the following equation to determine the force needed to induce onset of sinusoidal buckling using a curvilinear model.

$${F}_{s} = 2 \sqrt{\frac{{Elw}_{c}}{r}} \qquad ( Equation 2 )$$

where w_{c} is the constant force between the drillstring and wellbore, which, in turn, may be calculated using the following equation.

w_{c}=\sqrt{(w_{bp} sin θ+Fₕθ′)²+(F_{b} sin θ_{Φ}′)²} (Equation 3)

where Φ is the azimuth angle and ′ is the derivative with respect to measured depth.

In certain implementations for a constant curvature wellbore 165 the contact force may be expressed as

w_{c}=\sqrt{(w_{bp}n_{z}−FₕK)²+(w_{bp}b_{z})²} (Equation 4)

where n_{z} is vertical component of the normal to the curve and b_{z} is the vertical component of the binormal to the curve.

Example implementations of determining the axial force transfer efficiency of the drillstring (block 305) include modeling to determine the when the drillstring will experience a sinusoidal buckling mode. In one example implementation, the compression force to induce onset of helical buckling is determined using the following equation.

Fₕ=F×Fₛ (Equation 5)

where F is a buckling constant. Examples of the buckling constant include one or more of −2.83, −2.85, −2.4, −5.66, −3.75, −3.66, and −4.24.

In certain example implementations, as part of the determination of the axial force transfer efficiency of a drillstring (block 305), a Buckling Limit Factor (BLF) is calculated. The BLF may account for one or more factors that influence bucking of the drillstring. In general, the BLF is used to calibrate bucking models and adjust the buckling limits based on one or more of wellbore tortuosity, borehole quality, and borehole shape. An example factor that influences buckling is the lateral clearance of the wellbore 165. For example, a washout of a portion of wellbore 165 influences buckling. A second example factor that influences buckling is localized heating of the drillstring. Localized heating may be caused, for example, by fluid flows behind the drillstring. In certain implementations, the circulating fluid around the drillstring causes a fluid pressure change in the wellbore. The some situations, the fluid flow further causes fluid heat transfer between the drillpipe 140 and the wellbore 165. A third example factor that influences buckling is temperature increase, for example, due to drilling the borehole 165 or due to production from a formation. A fourth example factor that influences buckling is formation sticking. This condition may be caused, for example, by axial restraints along borehole 165. A fifth example factor that influences buckling is an incremental compressive load of the drillstring. This compressive load of the drillstring may be due to force applied either at the bit. The compressive loading may also be increased by tools such as a hole opener or by an underreamer in the drillstring. A sixth example factor that influences buckling is wellbore interaction with the drillstring. This may be caused, for example by friction of the wellbore on the borehole 165 and by side loading. A seventh example factor that influences buckling is the wellbore trajectory and tortuosity. In some implementations, one or more of the influencing factors are eliminated or not considered. In other example implementations, each of the influencing factors is considered.

Example implementations may account for one or more of these factors in the BLF. Using the BLF, the modified buckling force (F_{s(modified)}) may be determined using the following equation.

$${F}_{s ( modified )} = BLF \times 2 \sqrt{\frac{{EIw}_{c}}{r}} \qquad ( Equation 6 )$$

The compression force to induce onset of helical buckling may be calculated using the following equation.

Fₕ=F×F_{s(modified)} (Equation 7)

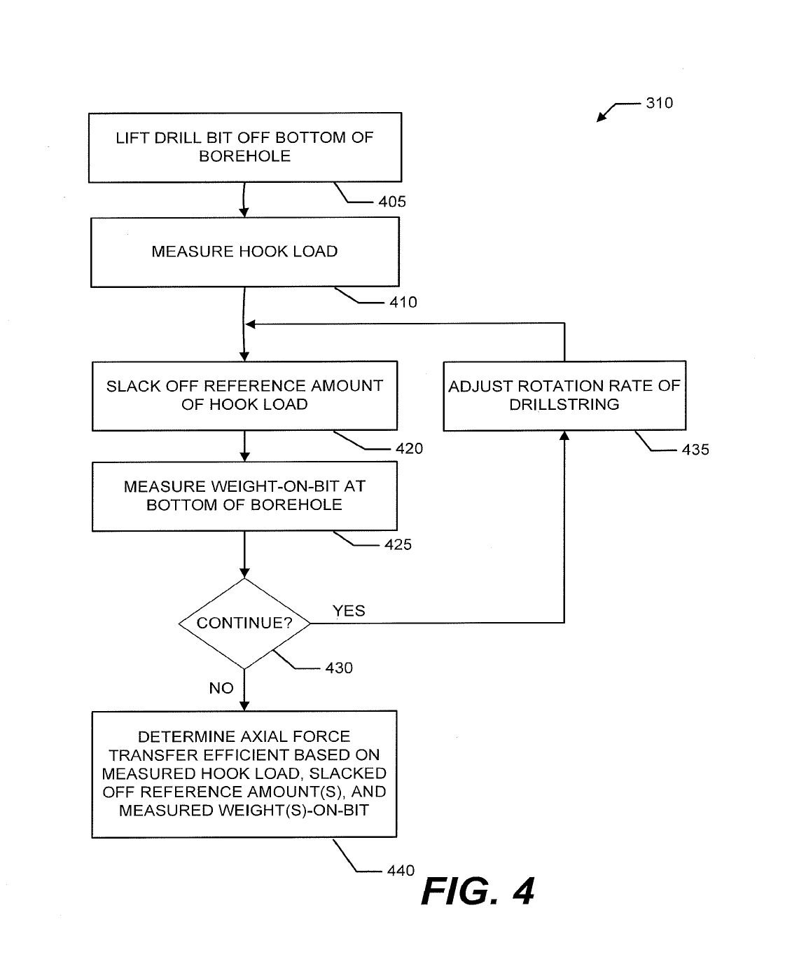

FIG. 4 show s a flow chart of an example process for modifying the axial force transfer efficiency based on a load transfer test (block 310). In block 410, the processor 180 lifts the drill bit 160 off the bottom of borehole 165. The processor 180 measures the hook load 410 with the drill bit off bottom (block 415).

In block 420, the processor 180 slacks off a reference amount of hook load. In some example embodiments, the processor 180 slacks off loads in increments of 5 kips, 10 kips, or an increment between 5 and 10 kips. In still other embodiments, the processor 180 increases hook load rather than slacking off. For example, in one implementation the hook load is increased in increments of 5 kips, 10 kips, or an increment between 5 and 10 kips.

In block 425, after having altered the hook load by either slacking off or increasing the hook load, the processor 180 measures the weight on bit at the bottom of the borehole 165. In some example implementations, the weight on bit is measured by a sensor in the BHA. In other example implementations, the weight of bit is measured by a sensor in one or more of subs 155.

In block 430, the processor 180 determines whether or not to repeat the process of altering the hook load and measuring the corresponding weight on bit (blocks 420 and 425). In some example implementations, the processor 180 repeats the process of slacking off a reference amount and measuring the weight on bit for two, three, four, five, or more iterations. In one embodiment, the process of slacking off a reference amount and measuring the weight on bit is repeated until the drillstring is in or near a lockup state and no more weight can be slacked off.

In some implementations, if the processor 180 determines that the process of slacking off a reference hook load and measuring the corresponding weight on bit (blocks 420 and 425) should be continued, the processor 180 adjusts the rotation rate of the drillstring before repeating the process. In one example implementation, the processor 180 increases the rate of rotation 5-10 RPM before repeating. In one example implementation, the processor 180 decreases the rate of rotation 5-10 RPM before repeating.

In block 440, the processor 180 determines the axial force transfer efficiency based, at least in part, on the measured hook load (from block 410), the one or more reference amount of hook load that were slacked off (from block 420), and the one or more corresponding weights on bit (from block 425). One example embodiment calculates a slack-off efficiency. In one example embodiment, the slack-off efficiency may be calculated using the following equation:

$$( {η}_{slackoff} = \frac{Δ WOB}{Δ HL} ) \qquad ( Equation 6 )$$

where ΔHL is the change in hook load (i.e., the amount load slacked off or added) and ΔWOB is the corresponding change in weights on bit.

Certain implementations may omit one or more of block 405-440. For example, modifying the axial force transfer efficiency based on a load transfer test (block 310) may be performed without first lifting the drill bit 160 off the bottom of the borehole 165. In such an implementation, the hook load may still be changed by adding hook load or slacking off hook load and corresponding changes in weight on bit are determined as described above.

In some implementations, the process for modifying the axial force transfer efficiency based on a load transfer test (block 310) is performed while the drillstring is not rotating. In other implementations, the for modifying the axial force transfer efficiency based on a load transfer test (block 310) is performed while the drillstring is rotating and the rate of rotation may or may not be altered during the execution of block 310. In some implementations, the process for modifying the axial force transfer efficiency based on a load transfer test (block 310) is performed while mud is circulated though the borehole 165. In other implementations, the process for modifying the axial force transfer efficiency based on a load transfer test (block 310) is performed without mud circulating though the borehole 165.

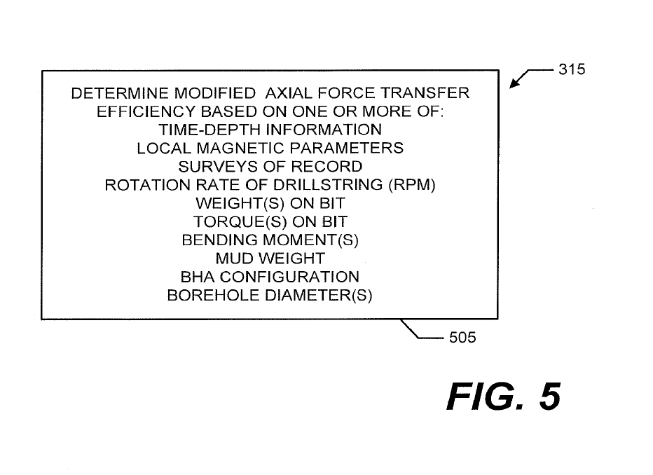

FIG. 5 is a flow chart showing an example process for modifying the axial force transfer efficiency based on collected data (block 325). One or more in-borehole measurements may be obtained from sensors in the BHA, sensors in one or more subs 155, or sensors at or near the surface. In some example implementations, the axial force transfer efficiency is modified based on time-depth information. In such implementations, the axial force transfer efficiency is modified based on a set of two or more time or depth versus hook load values. In some example implementations one or more sensors are located along the drillstring. The sensors measure properties indicative of hook load and send signals to the processor 180. In some example implementations, data is sent from the sensors to the processor 180 by a wired drill pipe. In other example implementations, data is sent from the sensors to the processor 180 by fiber optic cables in the drillstring. Certain implementations feature multiple sensors located on drillstring at different depths in the borehole. In certain implementations, drilling operations are paused while the sensor measure values indicative of hook load, while in other implementations sensor measurements are made without pausing drilling operations. In implementation where drilling operations are paused, afterward drilling operations are resumed resulting in the sensors being moved to a new depth in the borehole and measurements are taken again. In some implementations, the processor 180 interpolates the measurements taken at different depths to determine a change in hook load versus depth. The sensor may include one or more strain gauges. In some implementations the downhole sensors are sealed strain gauges.

In other example implementations, the axial force transfer efficiency is modified based on one or more local magnetic parameters. In still other implementations, the axial force transfer efficiency is modified based on surveys of record, which may include applied corrections. In still other implementations, the axial force transfer efficiency is modified based on the rate of rotation of the drillstring, which may be expressed in RPM. In some implementations, the axial force transfer efficiency is modified based on one or more measured weights on bit or torques on bit. In some implementations, the axial force transfer efficiency is modified based on measured bending moments in the drillstring. In some implementations, the axial force transfer efficiency is modified based on mud weight. In some implementations, the axial force transfer efficiency is modified based on the configuration of the BHA, for example based on the distances of sensors to the bit 160. In some implementations, the axial force transfer efficiency is modified based on dimensions of one or more segments of the borehole. Other data that is used for the determination of the axial force transfer efficiency includes one or more of hook-load, torque, stand-pipe pressure, fluid flow rate, and mud density.

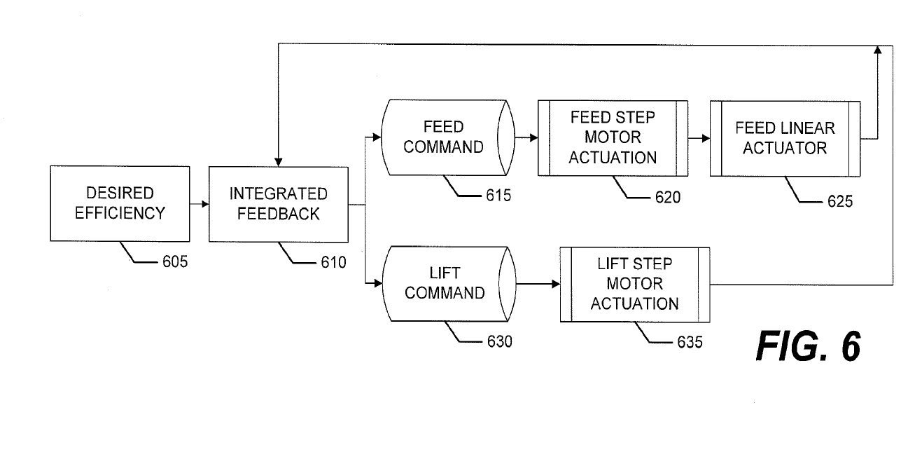

FIG. 6 is a flow chat of an example process for performing the load transfer test (block 310). The processor 180 may receive a desired efficiency 605. In one example implementation, the processor 180 receives the desired efficiency as an input to an integrated feedback algorithm 610. Based on the integrated feedback algorithm, the processor may issue a lift command 630 to decrease the weight on bit of the drillstring. This may be used, in one example implementation, to lift the drill bit 160 off the bottom of the borehole 165. This may be used, in a second example implementation, to increase the hook load by a predetermined amount. For example, the hook load may be incremented 5 kips, 10 kips, or between 5 and 10 kips. The lift command 630 may cause a lift step motor actuation 635 to perform the lift command 630. The results of the lift command 630 may be fed back to the integrated feedback algorithm 610. For example, the resulting weight on bit or the resulting hook load after the lift command 630 has been completed is considered by the processor 180 in certain implementations. In another example embodiment, the processor 180 may issue a feed command 615. This may be used in one example embodiment to slack off a predetermined amount of hook weight. Example implementations cause the slacking off of 5 kips, 10 kips, or an amount between 5 and 10 kips. The feed command 615 is accomplished, in example embodiments by one of a feed step motor actuation 620 or a feed linear actuation 625. For example, in the case of feed step motor actuation 620, the hook load or the weight on bit are changed in steps. In the case of feed linear actuation 625, the hook load or the weight on bit is changed continuously. The resulting output of the system may be fed back to integrated feedback algorithm 610. In some example implementations, the processor 180 receives the resulting weight on bit after the feed command 615 is accomplished.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A method for estimating an axial force transfer efficiency of a drillstring in a borehole, the drillstring comprising a drill bit, the method comprising:
lifting the drillstring so that the drill bit is off the bottom of the borehole;
measuring a hook load;
slacking off a first reference amount of the hook load;
determining a first weight on bit at the bottom of the drillstring; and
determining the axial force transfer efficiency based, at least in part, on the measured hook load, the first weight on bit, and the first reference amount of hook load.

2. The method of claim 1, further comprising:
slacking off a second reference amount of the hook load;
determining a second weight on bit at the bottom of the drillstring; and
wherein determining the axial force transfer efficiency is further based, at least in part, on the second weight on bit and the second reference amount of hook load.

3. The method of claim 2, further comprising:
slacking off one or more subsequent reference amounts of the hook load;
determining one or more corresponding subsequent weights on bit at the bottom of the drillstring; and
wherein determining the axial force transfer efficiency is further based, at least in part, on the one or more corresponding subsequent amounts of hook load and the one or more corresponding subsequent weights on bit.

4. The method of claim 3, wherein the first reference amount of hook load, the second reference amount of hook load, and the one or more subsequent amounts of hook load are between 5 and 10 kips.

5. The method of claim 2, wherein slacking off a first reference amount of the hook load and slacking off the second reference amount of the hook load are performed while the drillstring is rotating.

6. The method of claim 5, further comprising:
altering the rotation rate of the drillstring between slacking off the first reference amount of the hook load and slacking off the second reference amount of the hook load.

7. The method of claim 2, wherein slacking off the first reference amount of the hook load and slacking off the second reference amount of the hook load are performed while the drillstring is not rotating.

8. The method of claim 1, wherein determining an axial force transfer efficiency is further based, at least in part, on one or more of: one or more time-depth measurements from the drillstring; one or more local magnetic parameters; a rotation rate of the drillstring; a torque on bit of the drillstring; one or more bending moments of the drillstring; a mud weight; and one more borehole diameters.

9. The method of claim 1, further comprising:
performing a drilling operation in a subterranean formation; and
altering the rate of penetration of a wellbore in the subterranean formation based, at least in part, on the determined axial force transfer efficiency of the drillstring.

10. A system for controlling one or more drilling operations, comprising:
at least one processor; and
a memory including non-transitory executable instructions for estimating an axial force transfer efficiency of a drillstring, wherein the executable instructions cause at least one processor to:
lift the drillstring so that the drill bit is off the bottom of a borehole;
measure a hook load;
slack off a first reference amount of the hook load;
determine a first weight on bit at the bottom of the drillstring; and
determine an axial force transfer efficiency based, at least in part, on the measured hook load, the first weight on bit, and the first reference amount of hook load.

11. The system of claim 10, wherein the executable instructions further cause the at least one processor to:
slack off a second reference amount of the hook load;
determine a second weight on bit at the bottom of the drillstring; and
determine the axial force transfer efficiency based, at least in part, on the measured hook load, the first weight on bit, the second weight on bit, the first reference amount of hook load, and the second reference amount of hook load.

12. The system of claim 12, wherein the first reference amount and the second reference amount are between 5 and 10 kips.

13. The system of claim 10, wherein slacking off a first reference amount of the hook load and slacking off a second reference amount of the hook load are performed while the drillstring is rotating.

14. The system of claim 9, wherein the executable instructions further cause the at least one processor to:
altering the rotation rate of the drillstring between slacking off the first reference amount of the hook load and slacking off the second reference amount of the hook load.

15. The system of claim 10, wherein slacking off a first reference amount of the hook load and slacking off a second reference amount of the hook load are performed while the drillstring is not rotating.

16. The system of claim 10, wherein the executable instruction further cause the one processor to determine the axial force transfer efficiency further based, at least in part, on one or more of: one or more time-depth information; one or more local magnetic parameters; a rotation rate of the drillstring; a torque on bit of the drillstring; one or more bending moments of the drillstring; a mud weight; and one more borehole diameters.

17. The system of claim 10, wherein the executable instructions further cause the at least one processor to:
control a drilling operation in a subterranean formation; and
alter the rate of penetration of a wellbore in the subterranean formation based, at least in part, on the determined axial force transfer efficiency of the drillstring.

18. A system for controlling one or more drilling operations, comprising:
a drillstring including a drill bit;
at least one processor; and
a memory including non-transitory executable instructions for estimating an axial force transfer efficiency of a drillstring, wherein the executable instructions cause at least one processor to:
alter the hook load by a first reference amount;
measure a first weight on bit at the bottom of the drillstring;
alter the hook load by a second reference amount;
measure a second weight on bit at the bottom of the drillstring; and
determine an axial force transfer efficiency based, at least in part, on the first and second reference amounts of hook load, the first weight on bit, and the second weight on bit.

19. The system of claim 18, wherein:
the executable instructions that cause at least one processor to alter the hook load by a first reference amount cause the at least one processor to:
increase hook load by the first reference amount; and
the executable instructions that cause at least one processor to alter the hook load by a second reference amount cause the at least one processor to:
increase hook load by the second reference amount.

20. The system of claim 18, wherein the first reference amount and the second reference amount are between 5 and 10 kips.
